(19) United States
(12) Patent Application Publication
(10) Pub. No.: US 2014/0170872 A1
(43) Pub. Date: Jun. 19, 2014

(54) DATA CABLE WITH CONNECTOR

(71) Applicants: HONG FU PRECISION INDUSTRY (SHENZHEN) CO., LTD., Shenzhen (CN); HON HAI PRECISION INDUSTRY CO., LTD., New Taipei (TW)

(72) Inventors: XIAO-GANG YIN, Shenzhen (CN); GUO-YI CHEN, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/858,080

(22) Filed: Apr. 7, 2013

(30) Foreign Application Priority Data
Dec. 19, 2012 (CN) 201210553749.X

(51) Int. Cl. H01R 13/44

(52) U.S. Cl. CPC H01R 13/44
USPC 439/131

(57) ABSTRACT

A connector includes a frame, a female terminal, a male terminal, and an assistant member. The frame defines a receiving space which having an opening at an end of the frame, and a slot communicating with the slot in a side. The female terminal is permanently received in the receiving space. The male terminal is slidably received in the receiving space. The assistant member extends through the slot and bears on the male terminal to move the male terminal out of or into the receiving space through the opening, to enable the connector to function either as a female connector or as a male connector.

### BACKGROUND

1. Technical Field

The present disclosure relates to connectors for data cables.

2. Description of Related Art

Date cables generally include a cable wire, and a female terminal and a male terminal connected to opposite ends of the cable wire. As a result, where a data cable with two male terminals or two female terminals is used, another data cable with opposite terminals (two female terminals or two male terminals) needs to be prepared, which will increase the cost. Although data cables with a multiple terminals (a female terminal and a male terminal jointly extending from an end) are available now, this type of data cable is bulky and costly.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a data cable.

FIG. 2 is an assembled, isometric view of the data cable of FIG. 1.

FIG. 3 is similar to FIG. 2, but showing another state.

FIG. 4 is a partial, cross sectional view of the data cable of FIG. 3, taken along the cable IV-IV.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

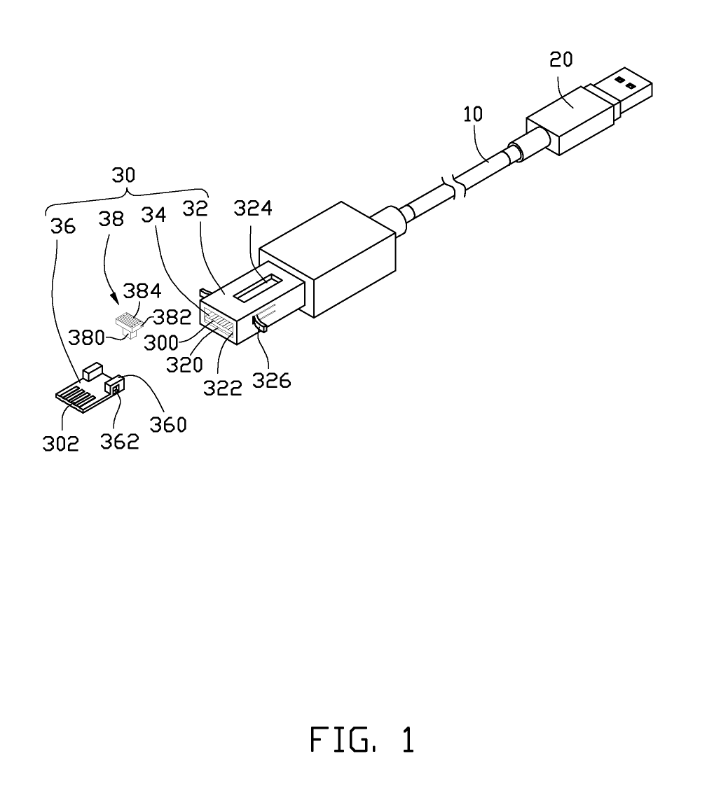

FIG. 1 shows an exemplary embodiment of a data cable. The data cable includes a cable 10, and a first connector 20 and a second connector 30 connected to opposite ends of the cable 10.

In this embodiment, the first connector 20 is a male terminal

The second connector 30 may function as a male connector or as a female connector. The second connector 30 includes a frame 32 fixed to an end of the cable 10, a female terminal 34 forming a plurality of first connection pins 300 on a first end of a surface, a male terminal 36 which is shorter than the female terminal 34 in length and forming a plurality of second connection pins 302 on a first end of a surface, and an assistant member 38.

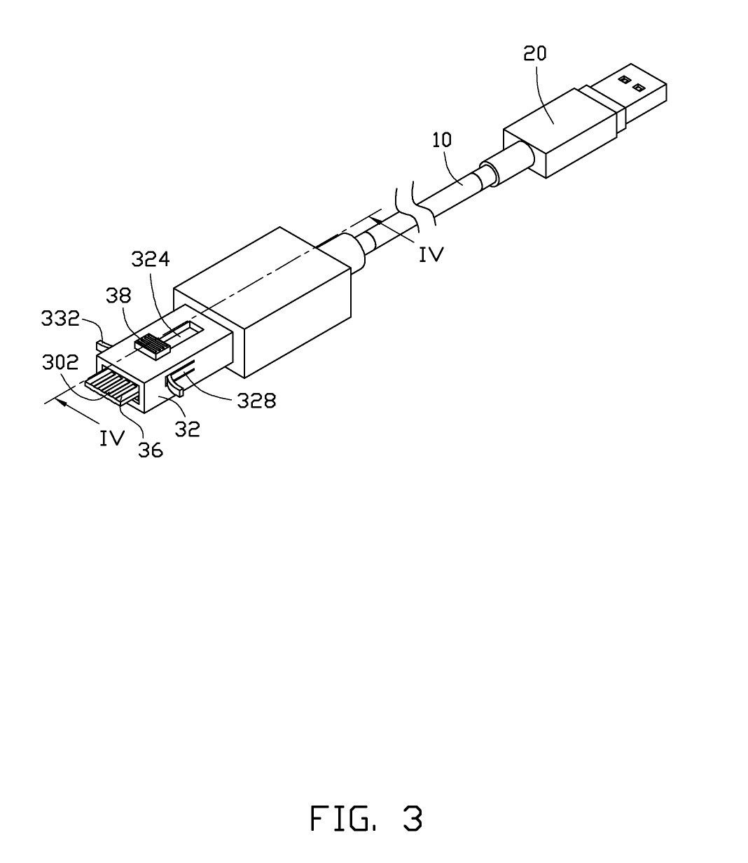

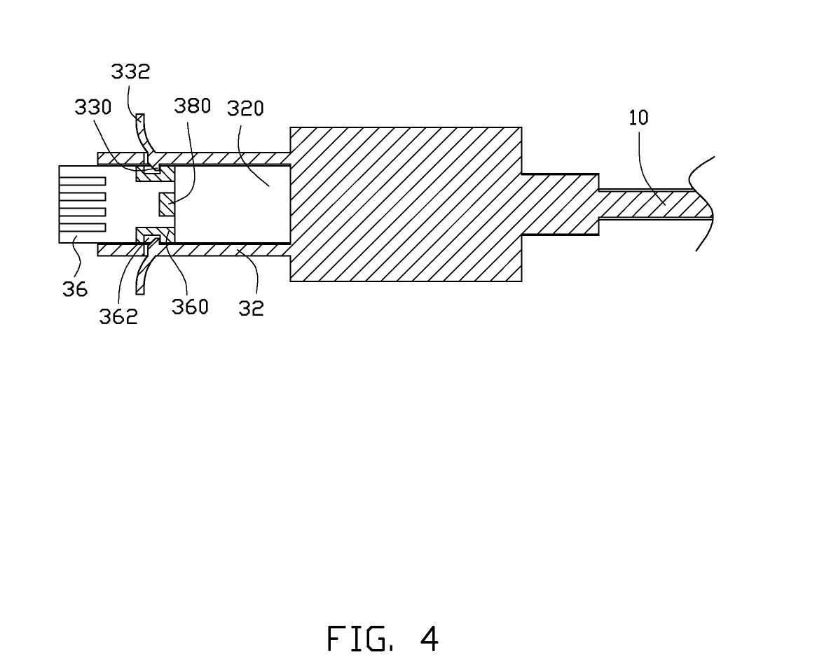

Referring to FIGS. 3 and 4, the frame 32 is longer than the first connector 20, and defines a receiving space 320. An opening 322 is defined in a distal end of the frame 32 opposite to the cable 10, and the receiving space 320 contains the female terminal 34. The top of the frame 32 defines a slot 324 communicating with the receiving space 320, the slot 324 extending lengthways towards the opening 322. Two latches 326 extend from opposite sides of the frame 32. Each latch 326 includes a resilient connecting piece 328 connected to the frame 32, a projection 330 extending into the receiving space 320 from a distal end of the connecting piece 328, an arc-shaped tab 332 extending out from the distal end of the connecting piece 328.

The female terminal 34 is firmly received in a lower portion of the receiving space 320, with the first connection pins 300 adjacent to the opening 322 and a second end of the female terminal 34, opposite to the connection pins 300, being electrically connected to the cable 10.

Two spaced blocks 360 protrude up from a top surface of the male terminal 36 and adjacent to a second end of the male terminal 36 opposite to the second connection pins 302. Each block 360 defines a recess 362 in a side opposite to the other block 360.

The assistant member 38 is substantially T-shaped, and includes a bar 380 and an operation portion 382 connected to a top end of the bar 380. An anti-skid portion 384, for better fingertip friction, is formed on a top surface of the operation portion 382.

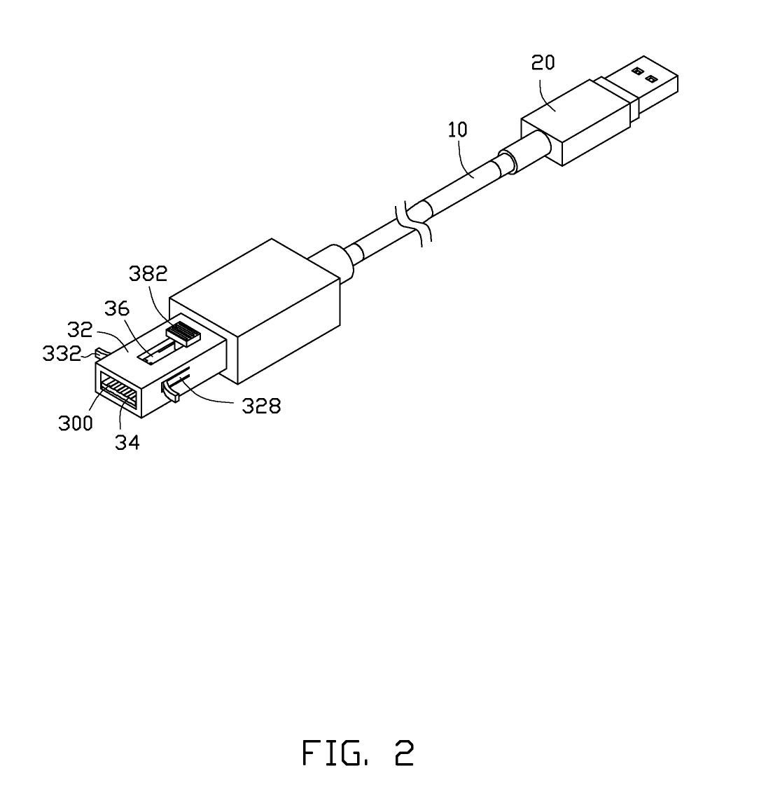

Referring to FIG. 2, in assembling the male terminal 36 to the frame 32, the second end of the male terminal 36 enters an upper portion of the receiving space 320 above the female terminal 34 through the opening 322, to be electrically connected to the cable 10. At this time, the male terminal 36 is completely received in the receiving space 320, and the second connection pins 302 are stacked immediately above the first connection pins 300. The bar 380 slidably extends through the slot 324 and is fixed to the top surface of the male terminal 36 between the blocks 360, to slidably mount the male terminal 36 in the frame 32. The bar 380 is mounted to the male terminal 36 by glue or a hot melt process. A bottom surface of the operation portion 382 is supported on the top surface of the frame 32.

In using the second connector 30 as a female connector, the assistant member 38 is moved to an end of the slot 324 away from the opening 322. Therefore, the male terminal 36 is fully retracted in the receiving space 320 and is away from the first connection pins 300.

Referring to FIGS. 3 and 4, in using the second connector 30 as a male connector, the tabs 332 are pushed toward each other to deform the connecting pieces 328 outward, thereby moving the projections 330 out of the receiving space 320. The operation portion 382 moves the male terminal 36 out of the receiving space 320 through the opening 322, until the recesses 362 align with and engage with the projections 330. The tabs 332 are released, and the connecting pieces 328 are restored to push the corresponding projections 330 to engage in the recesses 362, thereby fixing the slidable male terminal 36 in place. At this time, the second connection pins 302 are extended out of the opening 322.

In another embodiment, the data cable includes a cable 10 and two second connectors 30 connected at opposite ends of the cable 10.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A connector, comprising:
a frame defining a receiving space inside and a slot communicating with the receiving space in a side, the receiving space comprising an opening at an end of the frame;
a female terminal firmly received in a lower portion of the receiving space and comprising a plurality of first connection pins at a first end of the female terminal adjacent to the opening;
a male terminal slidably received in an upper portion of the receiving space, the male terminal comprising a plurality of second connection pins at a first end of the male terminal facing the opening; and
an assistant member slidably extending through the slot and fixed to the male terminal; wherein the assistant member is operable to move a portion of the male terminal comprising the second connection pins to extend out of the receiving space or withdraw into the receiving space through the opening.

2. The connector of claim 1, wherein a block protrudes from a top surface of the male terminal and defines a recess, a deformable latch is extended from the frame, the latch comprises a projection to engage in the recess in response to the portion of the male terminal forming the second connection pins being extended out of the receiving space.

3. The connector of claim 2, wherein the latch further comprises a resilient connecting piece connected to the frame and a tab connected to the connecting piece, the projection protrudes from a side of the connecting piece opposite to the tab, the tab is operable to deform the connecting piece away from the frame and disengage the projection from the recess.

4. The connector of claim 1, wherein the assistant member is substantially T-shaped, and comprises a bar extending through the slot and fixed to the male terminal, and an operation portion connected to a top end of the bar and supported on an outer surface of the frame.

5. A data cable, comprising:
a cable;
a first connector comprising:
a frame defining a receiving space inside and a slot communicating with the receiving space in a side, the receiving space comprising an opening at an end of the frame away from the cable;
a female terminal firmly received in a lower portion of the receiving space, the female terminal comprising a plurality of first connection pins formed at a first end of the female terminal adjacent to the opening and a second end electrically connected to a first end of the cable;
a male terminal slidably received in an upper portion of the receiving space, the male terminal comprising a first end electrically connected to the first end of the cable and a second end comprising a plurality of second connection pins; and
an assistant member slidably extending through the slot and fixed to the male terminal; wherein the assistant member is operable to move the male connector to extend out of the receiving space or withdraw into the receiving space through the opening.

6. The data cable of claim 5, wherein a block protrudes from a top surface of the male terminal and defines a recess, a deformable latch is extended from the frame, the latch comprises a projection to engage in the recess in response to the male connector being extended out of the receiving space.

7. The data cable of claim 6, wherein the latch further comprises a resilient connecting piece connected to the frame and a tab connected to the connecting piece, the projection protrudes from a side of the connecting piece opposite to the tab, the tab is operable to deform the connecting piece away from the frame and disengage the projection from the recess.

8. The data cable of claim 5, wherein the assistant member is substantially T-shaped, and comprises a bar extending through the slot and fixed to the male terminal, and an operation portion connected to a top end of the bar and located at an outer side of the frame.

9. The data cable of claim 5, further comprising a second connector connected to a second end of the cable opposite to the first connector.
